(19) United States
(12) Patent Application Publication
(10) Pub. No.: US 2010/0124682 A1
(43) Pub. Date: May 20, 2010

(54) FUEL CELL SYSTEM

(75) Inventor: Yasushi Kanai, Wako-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: HONDA MOTOR CO., LTD., Tokyo (JP)

(21) Appl. No.: 12/621,886

(22) Filed: Nov. 19, 2009

(30) Foreign Application Priority Data
Nov. 20, 2008 (JP) 2008-296744

(51) Int. Cl. H01M 8/04

(52) U.S. Cl. 429/25

(57) ABSTRACT

Fuel cell system includes: a fuel cell for outputting, via a pair of terminals, electric energy produced through reaction between oxygen contained in air supplied to an air electrode and hydrogen contained in fuel gas supplied to a fuel electrode; a subsidiary power supply device for supplying electric power to the terminals; a detection section for detecting a supplied pressure of the fuel gas; and a control section for, when the detected gas pressure is lower than required gas pressure, performing control to cause electric power, corresponding to a difference between the detected gas pressure and the required gas pressure, to be supplied from the subsidiary power supply device to the terminals.

### FIELD OF THE INVENTION

The present invention relates to fuel cell systems which can output, via a pair of output terminals, electric energy produced through reaction between oxygen contained in air and hydrogen contained in fuel gas.

### BACKGROUND OF THE INVENTION

To meet a growing demand for global environment protection, fuel cell systems have been in practical use which do not involve discharge of unwanted carbon dioxide gas. One example of such fuel cell systems is disclosed in Japanese Patent Application Laid-Open Publication No. 2004-235093 (hereinafter referred to as “the patent literature”).

FIG. 6 hereof is a view explanatory of the basic principles of the fuel cell system disclosed in the patent literature. In the fuel cell system 100 disclosed in the patent literature, hydrogen H₂ contained in fuel gas is supplied to a fuel electrode 102 located to the left of a power generation cell 101 while oxygen O₂ contained in air is supplied to an air electrode 103 located to the right of a power generation cell 101, so that electric power is supplied to an external apparatus via output terminals 104 and 105 connected to the power generation cell 101.

FIG. 7 hereof is a graph showing relationship between an output electric current and fuel gas pressure of the fuel cell system 100 disclosed in the patent literature, where the horizontal axis represents the fuel gas pressure P and the vertical axis represents the output electric current I. Since the electric power is proportional to the electric current if the electric voltage is assumed to be contact, the following description will be given, replacing the electric power of the fuel cell system 100 with the output electric current I. Because the fuel gas pressure P and the electric power I are in proportional relationship with each other in the fuel cell system 100, there would arise a need to increase the fuel gas pressure P while monitoring the fuel gas pressure P with a gas pressure sensor 106 of FIG. 6.

FIG. 8 is a graph showing variation of the fuel gas pressure in the fuel cell system 100, where the horizontal axis represents time T and the vertical axis represents the fuel gas pressure P. A solid line in the figure is a plot of settings of the fuel gas pressure P, while a broken line in the figure is a plot of actual measurements of the fuel gas pressure P that would increase with a time delay T_{L} from the settings for various reasons. Namely, because the actual fuel gas pressure is lower by a level P_{S} than the setting, the output electric current (FIG. 7) too would become short by an amount corresponding to the pressure shortage P_{S}, which would undesirably invite a temporary electric power shortage.

### SUMMARY OF THE INVENTION

In view of the foregoing prior art problems, it is an object of the present invention to provide an improved fuel cell system which can reliably avoid any undesired temporary electric power shortage.

In order to accomplish the above-mentioned object, the present invention provides an improved fuel cell system, which comprises: a fuel cell for outputting, via a pair of output terminals, electric energy produced through reaction between oxygen contained in air supplied to an air electrode and hydrogen contained in fuel gas supplied to a fuel electrode; a subsidiary power supply device for supplying electric power to the output terminals from outside the fuel cell; a gas pressure detection section for monitoring a gas pressure with which the fuel gas is supplied to the fuel electrode; and a control section for, when the gas pressure detected by the gas pressure detection section is lower than required gas pressure, performing control to cause electric power, corresponding to a difference between the detected gas pressure and the required gas pressure, to be supplied from the subsidiary power supply device to the output terminals.

According to the present invention, the subsidiary power supply device is provided for supplying (subsidiary) electric power, corresponding to a difference between the detected gas pressure and the required gas pressure, to the output terminals from outside the fuel cell. Thus, even when the electric power output from the fuel cell has run short temporarily, the electric power shortage can be supplemented with the electric power supplied from the subsidiary power supply device. In this way, the present invention can reliably avoid any temporary electric power shortage.

Further, in the present invention, the subsidiary power supply device is a secondary cell or a capacitor. Because the secondary cell or capacitor can repetitively store and discharge electric energy, the subsidiary power supply device can be used for a longer time than a primary cell. Preferably, the fuel cell system of the invention further comprises a storage section having prestored therein a gas pressure map and an output electric power map, and the control section determines, with reference to the gas pressure map and the output electric power map, the electric power to be supplied from the subsidiary power supply device to the terminals.

The following will describe embodiments of the present invention, but it should be appreciated that the present invention is not limited to the described embodiments and various modifications of the invention are possible without departing from the basic principles. The scope of the present invention is therefore to be determined solely by the appended claims.

### BRIEF DESCRIPTION OF THE DRAWINGS

Certain preferred embodiments of the present invention will hereinafter be described in detail, by way of example only, with reference to the accompanying drawings, in which:

FIG. 1 is a block diagram explanatory of the basic principles of a fuel cell system according to an embodiment of the present invention;

FIG. 2 is a diagram explanatory of a gas pressure map and an output electric current map employed in the fuel cell system;

FIG. 3 is a diagram explanatory of a manner in which an electric current correction amount is calculated on the basis of a difference between a measured gas pressure value and a gas pressure setting;

FIG. 4 is a block diagram showing an example detailed hardware setup of the fuel cell system;

FIG. 5 is a block diagram showing an example hardware setup of the control section employed in the fuel cell system;

FIG. 6 is a view illustrating the basic principles of a conventionally-known fuel cell system;

FIG. 7 is a graph showing relationship between an output electric current and fuel gas pressure in the conventionally-known fuel cell system; and

FIG. 8 is a graph showing variation of the fuel gas pressure in the conventionally-known fuel cell system.

### DETAILED DESCRIPTION OF THE PREFERRED EMBODIMENTS

The following description will be given hereinbelow in relation to a case where a subsidiary power supply device is a capacitor.

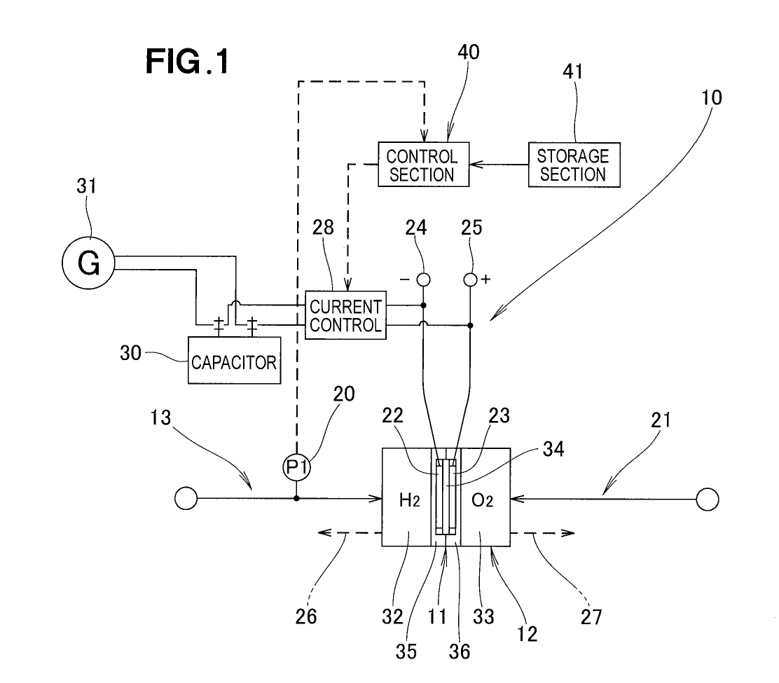

FIG. 1 is a block diagram explanatory of the basic principles of a fuel cell system 100 according to an embodiment of the present invention. The fuel cell system 10 includes: a fuel cell 12 having a power generation cell 11; a fuel gas supply unit 13 connected to the left side of the fuel cell 12 for supplying fuel gas to the fuel cell 12; a gas pressure detection section 20 provided in the fuel gas supply unit 13 for detecting or monitoring a supplied pressure of the fuel gas (i.e., a pressure with which the fuel gas is supplied to a fuel electrode 22; this pressure will hereinafter be referred to as “fuel gas pressure” or “gas pressure”); and an air supply unit 21 connected to the right side of the fuel cell 12 for supplying air to the fuel cell 12.

The power generation cell 11 includes the fuel electrode 22 which hydrogen H₂ contained in fuel gas supplied via the fuel gas supply unit 13 contacts, and an air electrode 23 which oxygen O₂ contained in air supplied via the air supply unit 21 contacts. By hydrogen 112 contacting the fuel electrode 22 and the oxygen O₂ contacting the air electrode 23, electric energy can be produced through reaction between the hydrogen H₂ and the oxygen O₂, and the thus-produced electric energy is provided or output via output terminals 24 and 25 electrically connected to the electrodes 22 and 23.

An unused portion of the supplied fuel gas is returned via a fuel gas returning unit 26, and an unused portion of the supplied air is returned via an air returning unit 27.

Normally, a combination of a plurality of the power generation cells 11 is used in an actual application; however, it is assumed here that only one such power generation cell 11 is provided, for convenience of description.

Further, in the fuel cell system 10, a capacitor 30, provided to function as the subsidiary power supply device, is connected to the terminals 24 and 25 via an electric current control 28. The capacitor 30 is an electric storage device provided for supplying subsidiary power to the terminals 24 and 25 from outside the fuel cell 12. The capacitor 30 can be used for a longer time than a primary cell because it can repetitively store and discharge electric energy.

The capacitor 30 need be replenished with electric energy as necessary. Thus, in the fuel cell system 10, the capacitor 30 is charged by a power generator 31 that may be a normal power source.

The fuel cell system 10 further includes a control section 40 that, when the fuel gas pressure detected by the gas pressure detection section 20 is lower than required fuel gas pressure, controls the electric current control 28 to cause an output electric current, corresponding to a difference between the detected pressure gas and the required gas pressure, to flow from the capacitor 30 to the terminals 24 and 25, and a storage section 41 connected to the control section 40 and having prestored therein a map indicative of relationship between possible values of the fuel gas pressure and time (i.e., gas pressure map) and a map indicative of relationship between possible values of the output electric current and time (i.e., output electric current map). The fuel cell system 10 further includes a fuel chamber 32, an air chamber 33, an electrolyte film 34, and separators 35 and 36.

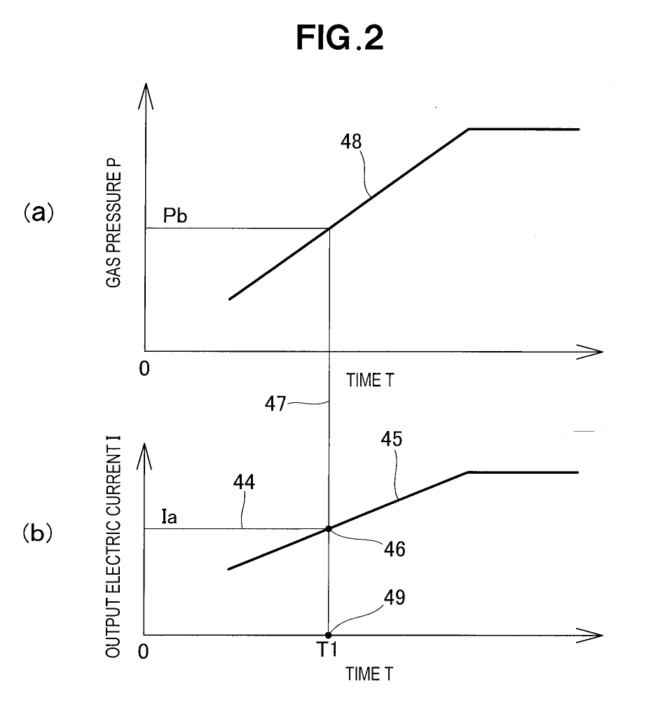

FIG. 2 is a diagram explanatory of the gas pressure map and the output electric current map prestored in the storage section 41. Namely, in the storage section 41 of FIG. 1 are stored in advance the gas pressure map indicative of the relationship between the gas pressure P and the time T (indicated at (a) of FIG. 2) and the output electric current map indicative of the relationship between the output electric current I and the time T (indicated at (b) of FIG. 2).

Once a target electric current value Ia is given, this target electric current value Ia is assigned to the vertical axis of (b) of FIG. 2, and then a horizontal line 44 is drawn rightward. Then, once the horizontal line 44 intersects an output current vs. time curve 45 at a point 46, a vertical line 47 is drawn upward from the point 46. Then, once the vertical line 47 intersects a gas pressure vs. time curve 48, a gas pressure value Pb at the point where the vertical line 47 has intersected the curve 48 is determined as a gas pressure setting Pb. Intersecting point between the vertical line 47 and the horizontal axis represents a time point T1.

Namely, if a gas pressure value Pb is given, a target electric current value Ia can be obtained. In other words, the gas pressure value Pb is necessary to generate the target electric current value Ia. Namely, at the time point T1, the gas pressure value is Pb, and the output electric current to be generated is Ia.

The control section 40 of FIG. 1 calculates correlationship among the output current I, time T and gas pressure P, using the maps in the aforementioned manner. The following description will be given, assuming that the above-mentioned gas pressure value Pb is defined as a gas pressure setting.

The following describe how an electric current correction amount is calculated on the basis of the above-mentioned gas pressure map and output electric current map.

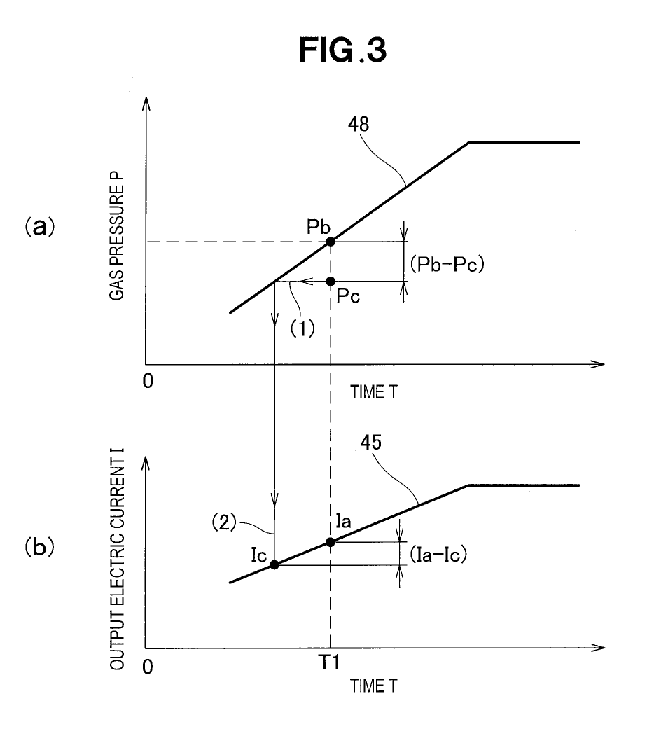

FIG. 3 is a diagram explanatory of a manner in which an electric current correction amount is calculated on the basis of a difference between a measured gas pressure value and the gas pressure setting, and (a) and (b) of FIG. 3 show the same gas pressure map and output electric current map as shown in (a) and (b) of FIG. 2.

Namely, in the illustrated example, a gas pressure value Pc is detected or measured at the time point T1. The measured gas pressure value Pc is smaller than the gas pressure setting Pb; namely, in this case, there is a pressure difference between the gas pressure setting Pb and the measured gas pressure value Pc (Pb−Pc). Thus, a horizontal line is drawn in (a) of FIG. 3 as indicated by a leftward arrow (1), and a vertical line is drawn in to (b) of FIG. 3 as indicated by a downward arrow (2). An output electric current value corresponding to the measured gas pressure value Pc is determined to be Ic, and thus, this output electric current value Ic is defined as a calculated electric current value.

In (b) of FIG. 3, a target electric current value at the time point T1 is Ia. Further, in this case, an actual output electric current value is Ic that is smaller than the target electric current value Ia, and thus, the output electric current correction amount (Ia-Ic) is determined as subsidiary electric applied which has to be applied to the terminals 24 and 25 from outside the fuel cell 12.

When a gas pressure value detected (measured) by the gas pressure detection section 20 is smaller than the gas pressure setting (i.e., required gas pressure), the capacitor 30 in the fuel cell system 10 of FIG. 1 is controlled to feed an electric current correction amount, corresponding to a difference between the detected gas pressure value and the gas pressure setting, to the terminals 24 and 25 of the fuel cell 12. Thus, even when the electric power produced or output from the fuel cell 12 has run short temporarily, the electric power shortage can be supplemented with the electric power supplied from the capacitor 30. In this way, the instant embodiment of the fuel cell system 10 can reliably avoid any temporary electric power shortage.

Whereas the fuel cell system 10 has been outlined above, the following describe the fuel cell system 10 in greater detail.

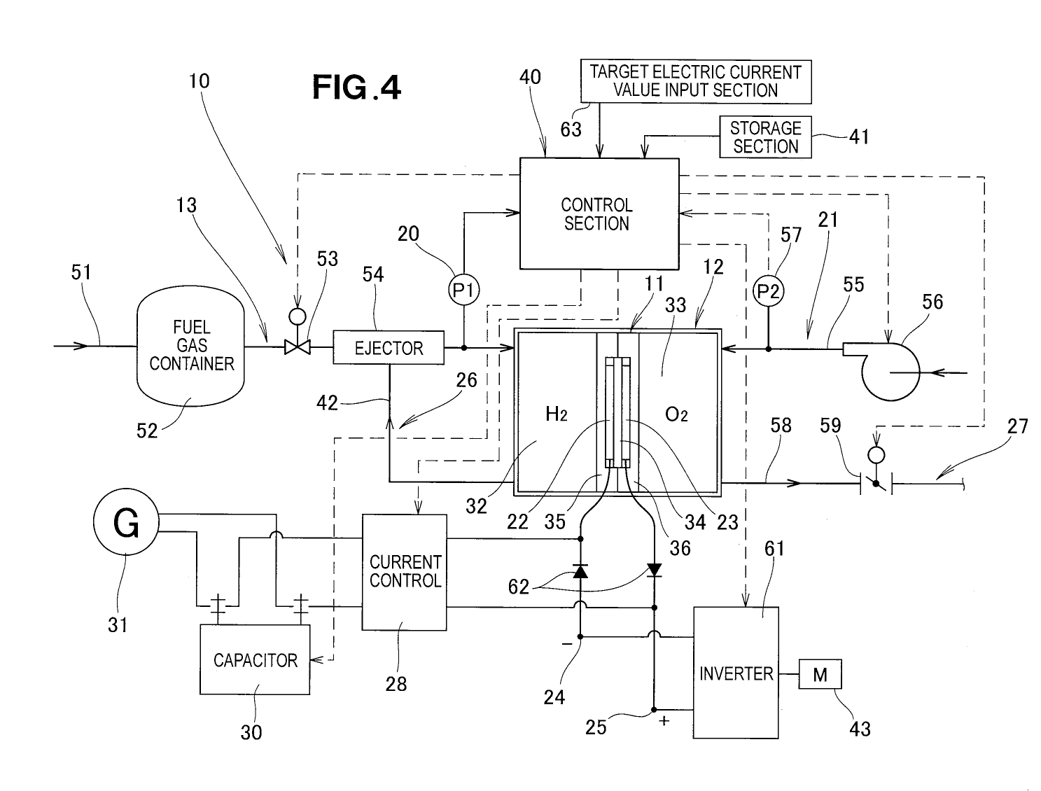

FIG. 4 is a block diagram showing an example detailed hardware setup of the fuel cell system 10, where similar elements to those in FIG. 1 are indicated by the same reference numerals and characters as used in FIG. 1. The fuel gas supply unit 13 includes: a fuel gas container 52 containing the fuel gas and connected to the fuel cell 12 via a fuel gas supply pipe 51; a supplied gas adjusting valve 53 provided in a portion of the fuel gas supply pipe 51 located rightwardly or downstream of the fuel gas container 52 (i.e., closer to the fuel cell 12 than the fuel gas container 52) for adjusting a flow rate of the fuel gas; and an ejector 54 provided in a portion of the fuel gas supply pipe 51 located downstream of the supplied gas adjusting valve 53 for supplying the fuel gas to the fuel electrode 22.

The fuel gas returning unit 26 includes a fuel gas returning pipe 42 provided for returning an unused portion of the supplied fuel gas from the fuel chamber 32 to the ejector 54.

The air supply unit 21 includes an air blower 56 connected to the fuel cell 12 via an air supply pipe 55 for supplying air to the air electrode 23, and an air pressure detection section 57 provided in a portion of the air supply pipe 55 between the air blower 56 and the air chamber 33 for monitoring a supplied pressure of the air (i.e., a pressure with which the air is supplied to the air electrode 23).

Further, the air returning unit 27 includes an air returning pipe 58, and an air adjusting valve 59 provided in the air returning pipe 58.

Furthermore, an electric motor 43 is connected to the terminals 24 and 25 via an inverter 61 so that electric power produced by the fuel cell system 10 can be supplied to the electric motor 43. Reference numeral 62 indicates a diode, and 63 is a target electric current value input section.

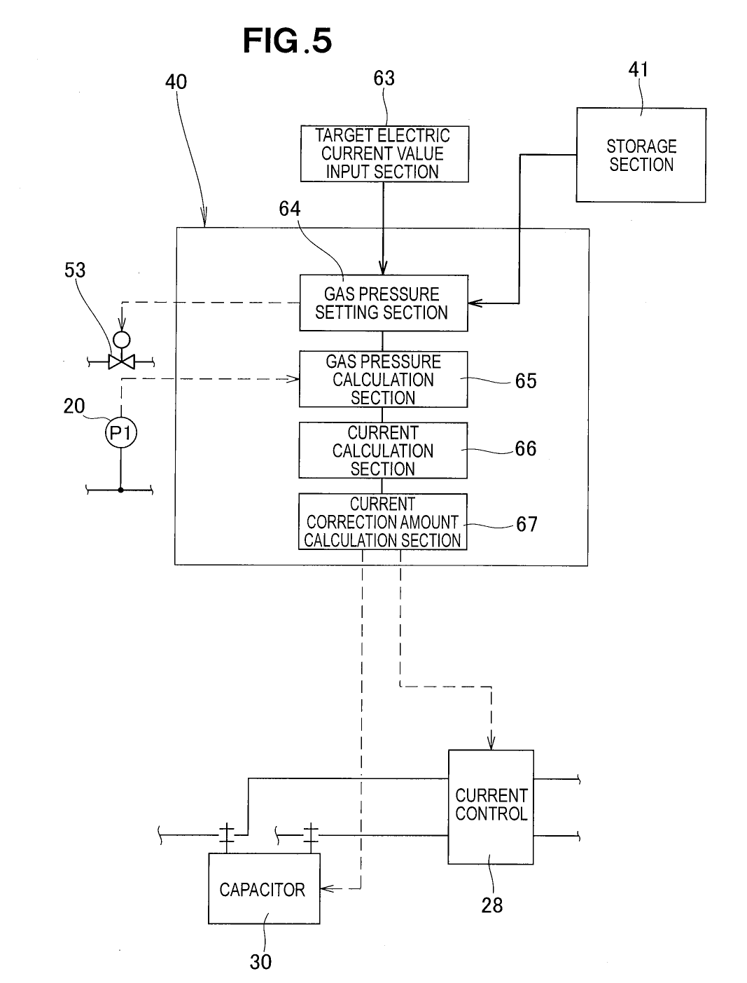

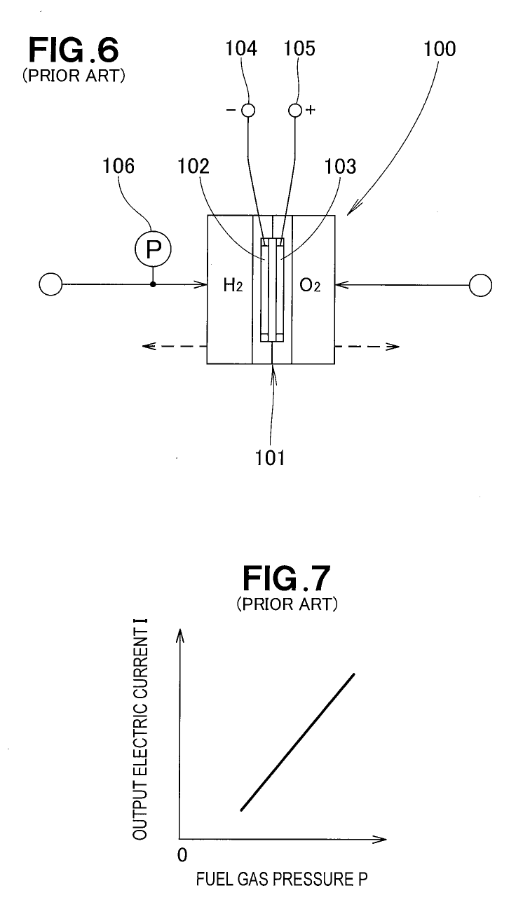

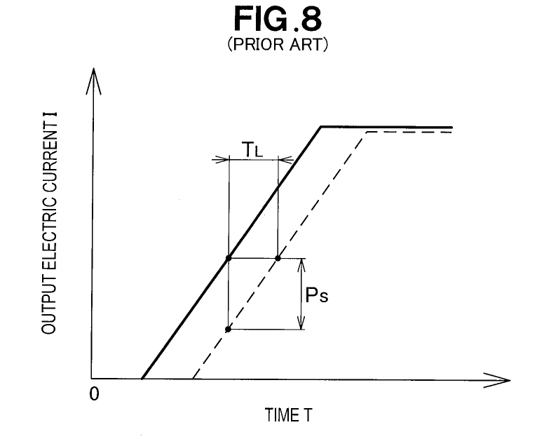

FIG. 5 is a block diagram showing an example hardware setup of the control section 40 employed in the embodiment of the fuel cell system 10. The control section 40 includes: a gas pressure setting section 64 connected not only to the target electric current value input section 63 but also to the storage section 41; a gas pressure calculation section 65 connected to the gas pressure setting section 64; an electric current calculation section 66 connected to the gas pressure calculation section 65; and an electric current correction amount calculation section 67 connected to the electric current calculation section 66.

The target electric current value input section 63 is a section via which a human operator inputs a target electric current value Ia (see FIG. 2). The storage section 41 is a section having prestored therein the gas pressure map ((a) of FIG. 2) and the output electric current map ((b) of FIG. 2).

The gas pressure setting section 64 is a section that determines a gas pressure setting Pb in accordance with a target electric current value Ia input via the target electric current value input section 63 and on the basis of the gas pressure map, as set forth above in relation to FIG. 2.

The gas pressure calculation section 65 is a section that determines a difference between the gas pressure setting Pb and a measured gas pressure value Pc (i.e., Pb−Pc) in accordance with the input target electric current value Ia and on the basis of the gas pressure map, as set forth above in relation to (a) of FIG. 3.

The electric current calculation section 66 is a section that determines a calculated electric current value Ic corresponding to the measured gas pressure value Pc on the basis of the output electric current map, as set forth above in relation to (b) of FIG. 3.

Further, the electric current correction amount calculation section 67 determines an output electric current correction amount (Ia-IC) on the basis of the output electric current map.

Whereas the embodiment of the fuel cell system 100 has been described as determining an electric current correction amount in accordance with a difference between the gas pressure setting and the measured (detected) gas pressure value, an electric voltage correction amount or electric power correction amount may be determined in accordance with a difference between the gas pressure setting and the measured (detected) gas pressure value; in such a case, not only the gas pressure map but also a map indicative of relationship between possible values of the output electric voltage or output electric power are prestored in the storage section 41.

Further, whereas the fuel cell system 100 of the present invention has been described as using a capacitor as the subsidiary power supply device, the subsidiary power supply device may be any other suitable device than a capacitor, such as an ordinary power supply device like a secondary cell, as long as it can supply electric power to the output terminals 24 and 25.

The fuel cell system of the present invention is well suited for application to power generation apparatus.

What is claimed is:

1. A fuel cell system comprising:
a fuel cell for outputting, via a pair of output terminals, electric energy produced through reaction between oxygen contained in air supplied to an air electrode and hydrogen contained in fuel gas supplied to a fuel electrode;
a subsidiary power supply device for supplying electric power to the terminals from outside the fuel cell;
a gas pressure detection section for monitoring a gas pressure with which the fuel gas is supplied to the fuel electrode; and
a control section for, when the gas pressure detected by the gas pressure detection section is lower than required gas pressure, performing control to cause electric power, corresponding to a difference between the detected gas pressure and the required gas pressure, to be supplied from the subsidiary power supply device to the terminals.

2. The fuel cell system of claim 1, wherein the subsidiary power supply device is a secondary cell or a capacitor.

3. The fuel cell system of claim 1, further comprising a storage section having prestored therein a gas pressure map and an output electric power map, and wherein the control section determines, with reference to the gas pressure map and the output electric power map, the electric power to be supplied from the subsidiary power supply device to the terminals.
